(19) United States
(12) Patent Application Publication
(10) Pub. No.: US 2020/0115135 A1
(43) Pub. Date: Apr. 16, 2020

(54) Packaging with Three-Dimensional Loop Material

(71) Applicant: Dow Global Technologies LLC, Midland, MI (US)

(72) Inventors: Sheng Li, Shanghai (CN); Bin Li, Shanghai (CN); Viraj K. Shah, Freeport, TX (US); Xiangi Yang, Shanghai (CN); Bruno Rufato Pereira, Sao Paulo (BR)

(21) Appl. No.: 16/618,313

(22) PCT Filed: May 31, 2017
(86) PCT No.: PCT/CN2017/086555

§ 371 Date: Nov. 29, 2019

(51) Int. Cl. B65D 81/18; B65D 81/127; B65D 77/04; A23L 3/36; A23B 4/06; B65D 81/38; B65D 85/50; A01K 63/02

(52) U.S. Cl. CPC B65D 81/18; B65D 81/127; B65D 77/04; A01K 63/02; A23B 4/068; B65D 81/3825; B65D 85/50; A23L 3/364

(57) ABSTRACT

A packaging article (10, 110, 210) is disclosed. In an embodiment, the packaging article (10, 110, 210) includes (A) an insulation container (12, 112, 212) having side walls (14, 114, 214) and a bottom wall (16, 116, 216), the walls defining a compartment (20, 120, 220), (B) a cold source (22, 122, 222) in the compartment (20, 120, 220), and (C) a sheet of 3-dimensional random loop material (3DRLM) (30,130, 230) in the compartment (20, 120, 220).

### BACKGROUND

Temperature sensitive products typically require a temperature controlled supply chain, also known as a “cold chain.” An unbroken cold chain is an uninterrupted series of refrigerated production, storage and distribution activities and associated equipment which maintain a given low-temperature range. The cold chain is used to ensure efficacy in the case of temperature sensitive products such as medicines and vaccines. The cold chain is also used to extend shelf life temperature sensitive products such as fresh produce, seafood, frozen food, photographic film, and chemicals. Unlike other goods or merchandise, temperature sensitive products are perishable and always en route towards end use or destination, even when held temporarily in cold store.

Ensuring a specific temperature range throughout the shipping process is essential to the quality of temperature sensitive products. As such, the art recognizes the on-going need for reliable and cost effective shipping containers for use in the cold chain.

### SUMMARY

The present disclosure provides a packaging article. In an embodiment, the packaging article includes (A) an insulation container having side walls and a bottom wall, the walls defining a compartment, (B) a cold source in the compartment, and (C) a sheet of 3-dimensional random loop material (3DRLM) in the compartment.

### DEFINITIONS AND TEST METHODS

All references to the Periodic Table of the Elements herein shall refer to the Periodic Table of the Elements, published and copyrighted by CRC Press, Inc., 2003. Also, any references to a Group or Groups shall be to the Groups or Groups reflected in this Periodic Table of the Elements using the IUPAC system for numbering groups. Unless stated to the contrary, implicit from the context, or customary in the art, all components and percents are based on weight. For purposes of United States patent practice, the contents of any patent, patent application, or publication referenced herein are hereby incorporated by reference in their entirety (or the equivalent US version thereof is so incorporated by reference).

The numerical ranges disclosed herein include all values from, and including, the lower value and the upper value. For ranges containing explicit values (e.g., 1, or 2, or 3 to 5, or 6, or 7) any subrange between any two explicit values is included (e.g., 1 to 2; 2 to 6; 5 to 7; 3 to 7; 5 to 6; etc.).

Unless stated to the contrary, implicit from the context, or customary in the art, all components and percents are based on weight, and all test methods are current as of the filing date of this disclosure.

Apparent density. A sample material is cut into a square piece of 38 cm×38 cm (15 in×15 in) in size. The volume of this piece is calculated from the thickness measured at four points. The division of the weight by the volume gives the apparent density (an average of four measurements is taken) with values reported in grams per cubic centimeter, g/cc.

Bending Stiffness. The bending stiffness is measured in accordance with DIN 53121 standard, with compression molded plaques of 550 μm thickness, using a Frank-PTI Bending Tester. The samples are prepared by compression molding of resin granules per ISO 293 standard. Conditions for compression molding are chosen per ISO 1872-2007 standard. The average cooling rate of the melt is 15° C./min. Bending stiffness is measured in 2-point bending configuration at room temperature with a span of 20 mm, a sample width of 15 mm, and a bending angle of 40°. Bending is applied at 6°/second (s) and the force readings are obtained from 6 to 600 s, after the bending is complete. Each material is evaluated four times with results reported in Newton millimeters (“Nmm”).

“Blend,” “polymer blend” and like terms is a composition of two or more polymers. Such a blend may or may not be miscible. Such a blend may or may not be phase separated. Such a blend may or may not contain one or more domain configurations, as determined from transmission electron spectroscopy, light scattering, x-ray scattering, and any other method known in the art. Blends are not laminates, but one or more layers of a laminate can comprise a blend.

¹³C Nuclear Magnetic Resonance (NMR)

Sample Preparation

The samples are prepared by adding approximately 2.7 g of a 50/50 mixture of tetrachloroethane-d2/orthodichlorobenzene that is 0.025M in chromium acetylacetonate (relaxation agent) to 0.21 g sample in a 10 mm NMR tube. The samples are dissolved and homogenized by heating the tube and its contents to 150° C.

Data Acquisition Parameters

The data is collected using a Bruker 400 MHz spectrometer equipped with a Bruker Dual DUL high-temperature CryoProbe. The data is acquired using 320 transients per data file, a 7.3 sec pulse repetition delay (6 sec delay+1.3 sec acq. time), 90 degree flip angles, and inverse gated decoupling with a sample temperature of 125° C. All measurements are made on non-spinning samples in locked mode. Samples are homogenized immediately prior to insertion into the heated (130° C.) NMR Sample changer, and are allowed to thermally equilibrate in the probe for 15 minutes prior to data acquisition.

“Composition” and like terms is a mixture of two or more materials. Included in compositions are pre-reaction, reaction and post-reaction mixtures, the latter of which will include reaction products and by-products as well as unreacted components of the reaction mixture and decomposition products, if any, formed from the one or more components of the pre-reaction or reaction mixture.

The terms “comprising,” “including,” “having,” and their derivatives, are not intended to exclude the presence of any additional component, step or procedure, whether or not the same is specifically disclosed. In order to avoid any doubt, all compositions claimed through use of the term “comprising” may include any additional additive, adjuvant, or compound, whether polymeric or otherwise, unless stated to the contrary. In contrast, the term, “consisting essentially of” excludes from the scope of any succeeding recitation any other component, step or procedure, excepting those that are not essential to operability. The term “consisting of” excludes any component, step or procedure not specifically delineated or listed.

Crystallization Elution Fractionation (CEF) Method

Comonomer distribution analysis is performed with Crystallization Elution Fractionation (CEF) (PolymerChar in Spain) (B Monrabal et al, Macromol. Symp. 257, 71-79 (2007)). Ortho-dichlorobenzene (ODCB) with 600 ppm antioxidant butylated hydroxytoluene (BHT) is used as solvent. Sample preparation is done with autosampler at 160° C. for 2 hours under shaking at 4 mg/ml (unless otherwise specified). The injection volume is 300 μm. The temperature profile of CEF is: crystallization at 3° C./min from 110° C. to 30° C., the thermal equilibrium at 30° C. for 5 minutes, elution at 3° C./min from 30° C. to 140° C. The flow rate during crystallization is at 0.052 ml/min. The flow rate during elution is at 0.50 ml/min. The data is collected at one data point/second. CEF column is packed by the Dow Chemical Company with glass beads at 125 μm+6% (MO-SCI Specialty Products) with ⅛ inch stainless tubing. Glass beads are acid washed by MO-SCI Specialty with the request from The Dow Chemical Company. Column volume is 2.06 ml. Column temperature calibration is performed by using a mixture of NIST Standard Reference Material Linear polyethylene 1475a (1.0 mg/ml) and Eicosane (2 mg/ml) in ODCB. Temperature is calibrated by adjusting elution heating rate so that NIST linear polyethylene 1475a has a peak temperature at 101.0° C., and Eicosane has a peak temperature of 30.0° C. The CEF column resolution is calculated with a mixture of NIST linear polyethylene 1475a (1.0 mg/ml) and hexacontane (Fluka, purum, >97.0 , 1 mg/ml). A baseline separation of hexacontane and NIST polyethylene 1475a is achieved. The area of hexacontane (from 35.0 to 67.0° C.) to the area of NIST 1475a from 67.0 to 110.0° C. is 50 to 50, the amount of soluble fraction below 35.0° C. is <1.8 wt %. The CEF column resolution is defined in the following equation:

$$Resolution = \frac{\begin{matrix}Peak temperature of NIST 1475 a - \\ Peak Temperature of Hexacontane\end{matrix}}{\begin{matrix}Half - height Width of NIST 1475 a + \\ Half - height Width of Hexacontane\end{matrix}}$$

where the column resolution is 6.0.

Density is measured in accordance with ASTM D 792 with values reported in grams per cubic centimeter, g/cc.

Differential Scanning calorimetry (DSC). Differential Scanning calorimetry (DSC) is used to measure the melting and crystallization behavior of a polymer over a wide range of temperatures. For example, the TA Instruments Q1000 DSC, equipped with an RCS (refrigerated cooling system) and an autosampler is used to perform this analysis. During testing, a nitrogen purge gas flow of 50 ml/min is used. Each sample is melt pressed into a thin film at about 175° C.; the melted sample is then air-cooled to room temperature (approx. 25° C.). The film sample is formed by pressing a “0.1 to 0.2 gram” sample at 175° C. at 1,500 psi, and 30 seconds, to form a “0.1 to 0.2 mil thick” film. A 3-10 mg, 6 mm diameter specimen is extracted from the cooled polymer, weighed, placed in a light aluminum pan (ca 50 mg), and crimped shut. Analysis is then performed to determine its thermal properties. The thermal behavior of the sample is determined by ramping the sample temperature up and down to create a heat flow versus temperature profile. First, the sample is rapidly heated to 180° C., and held isothermal for five minutes, in order to remove its thermal history. Next, the sample is cooled to −40° C., at a 10° C./minute cooling rate, and held isothermal at −40° C. for five minutes. The sample is then heated to 150° C. (this is the “second heat” ramp) at a 10° C./minute heating rate. The cooling and second heating curves are recorded. The cool curve is analyzed by setting baseline endpoints from the beginning of crystallization to −20° C. The heat curve is analyzed by setting baseline endpoints from −20° C. to the end of melt. The values determined are peak melting temperature (Tm), peak crystallization temperature (Tc), onset crystallization temperature (Tc onset), heat of fusion (Hf) (in Joules per gram), the calculated % crystallinity for polyethylene samples using: % Crystallinity for PE=((Hf)/(292 J/g))×100, and the calculated % crystallinity for polypropylene samples using: % Crystallinity for PP=((Hf)/165 J/g))×100. The heat of fusion (Hf) and the peak melting temperature are reported from the second heat curve. Peak crystallization temperature and onset crystallization temperature are determined from the cooling curve

Elastic Recovery. Resin pellets are compression molded following ASTM D4703, Annex Al, Method C to a thickness of approximately 5-10 mil. Microtensile test specimens of geometry as detailed in ASTM D1708 are punched out from the molded sheet. The test specimens are conditioned for 40 hours prior to testing in accordance with Procedure A of Practice D618.

The samples are tested in a screw-driven or hydraulically-driven tensile tester using flat, rubber faced grips. The grip separation is set at 22 mm, equal to the gauge length of the microtensile specimens. The sample is extended to a strain of 100% at a rate of 100%/min and held for 30 s. The crosshead is then returned to the original grip separation at the same rate and held for 60 s. The sample is then strained to 100% at the same 100%/min strain rate.

Elastic recovery may be calculated as follows:

$$Elastic Recovery = \frac{( Initial Applied Strain - Permanent Set )}{Initial Applied Strain} \times 100 \%$$

An “ethylene-based polymer” is a polymer that contains more than 50 weight percent polymerized ethylene monomer (based on the total weight of polymerizable monomers) and, optionally, may contain at least one comonomer. Ethylene-based polymer includes ethylene homopolymer, and ethylene copolymer (meaning units derived from ethylene and one or more comonomers). The terms “ethylene-based polymer” and “polyethylene” may be used interchangeably. Nonlimiting examples of ethylene-based polymer (polyethylene) include low density polyethylene (LDPE) and linear polyethylene. Nonlimiting examples of linear polyethylene include linear low density polyethylene (LLDPE), ultra low density polyethylene (ULDPE), very low density polyethylene (VLDPE), multi-component ethylene-based copolymer (EPE), ethylene/α-olefin multi-block copolymers (also known as olefin block copolymer (OBC)), single-site catalyzed linear low density polyethylene (m-LLDPE), substantially linear, or linear, plastomers/elastomers, and high density polyethylene (HDPE). Generally, polyethylene may be produced in gas-phase, fluidized bed reactors, liquid phase slurry process reactors, or liquid phase solution process reactors, using a heterogeneous catalyst system, such as Ziegler-Natta catalyst, a homogeneous catalyst system, comprising Group 4 transition metals and ligand structures such as metallocene, non-metallocene metal-centered, heteroaryl, heterovalent aryloxyether, phosphinimine, and others. Combinations of heterogeneous and/or homogeneous catalysts also may be used in either single reactor or dual reactor configurations.

“High density polyethylene” (or “HDPE”) is an ethylene homopolymer or an ethylene/α-olefin copolymer with at least one C₄-C₁₀ α-olefin comonomer, or C₄-C₈ α-olefin comonomer and a density from greater than 0.94 g/cc, or 0.945 g/cc, or 0.95 g/cc, or 0.955 g/cc to 0.96 g/cc, or 0.97 g/cc, or 0.98 g/cc. The HDPE can be a monomodal copolymer or a multimodal copolymer. A “monomodal ethylene copolymer” is an ethylene/C₄-C₁₀ α-olefin copolymer that has one distinct peak in a gel permeation chromatography (GPC) showing the molecular weight distribution. A “multimodal ethylene copolymer” is an ethylene/C₄-C₁₀ α-olefin copolymer that has at least two distinct peaks in a GPC showing the molecular weight distribution. Multimodal includes copolymer having two peaks (bimodal) as well as copolymer having more than two peaks. Nonlimiting examples of HDPE include DOW™ High Density Polyethylene (HDPE) Resins (available from The Dow Chemical Company), ELITE™ Enhanced Polyethylene Resins (available from The Dow Chemical Company), CONTINUUM™ Bimodal Polyethylene Resins (available from The Dow Chemical Company), LUPOLEN™ (available from LyondellBasell), as well as HDPE products from Borealis, Ineos, and ExxonMobil.

An “interpolymer” is a polymer prepared by the polymerization of at least two different monomers. This generic term includes copolymers, usually employed to refer to polymers prepared from two different monomers, and polymers prepared from more than two different monomers, e.g., terpolymers, tetrapolymers, etc.

“Low density polyethylene” (or “LDPE”) consists of ethylene homopolymer, or ethylene/α-olefin copolymer comprising at least one C₃-C₁₀ α-olefin, preferably C₃-C₄that has a density from 0.915 g/cc to 0.940 g/cc and contains long chain branching with broad MWD. LDPE is typically produced by way of high pressure free radical polymerization (tubular reactor or autoclave with free radical initiator). Nonlimiting examples of LDPE include MarFlex™ (Chevron Phillips), LUPOLEN™ (LyondellBasell), as well as LDPE products from Borealis, Ineos, ExxonMobil, and others.

“Linear low density polyethylene” (or “LLDPE”) is a linear ethylene/α-olefin copolymer containing heterogeneous short-chain branching distribution comprising units derived from ethylene and units derived from at least one C₃-C₁₀ α-olefin comonomer or at least one C₄-C₈ α-olefin comonomer, or at least one C₆-C₈ α-olefin comonomer. LLDPE is characterized by little, if any, long chain branching, in contrast to conventional LDPE. LLDPE has a density from 0.910 g/cc, or 0.915 g/cc, or 0.920 g/cc, or 0.925 g/cc to 0.930 g/cc, or 0.935 g/cc, or 0.940 g/cc. Nonlimiting examples of LLDPE include TUFLIN™ linear low density polyethylene resins (available from The Dow Chemical Company), DOWLEX™ polyethylene resins (available from the Dow Chemical Company), and MARLEX™ polyethylene (available from Chevron Phillips).

“Ultra low density polyethylene” (or “ULDPE”) and “very low density polyethylene” (or “VLDPE”) each is a linear ethylene/α-olefin copolymer containing heterogeneous short-chain branching distribution comprising units derived from ethylene and units derived from at least one C₃-C₁₀ α-olefin comonomer, or at least one C₄-C₈ α-olefin comonomer, or at least one C₆-C₈ α-olefin comonomer. ULDPE and VLDPE each has a density from 0.885 g/cc, or 0.90 g/cc to 0.915 g/cc. Nonlimiting examples of ULDPE and VLDPE include ATTANE™ ultra low density polyethylene resins (available form The Dow Chemical Company) and FLEXOMER™ very low density polyethylene resins (available from The Dow Chemical Company).

“Multi-component ethylene-based copolymer” (or “EPE”) comprises units derived from ethylene and units derived from at least one C₃-C₁₀ α-olefin comonomer, or at least one C₄-C₈ α-olefin comonomer, or at least one C₆-C₈ α-olefin comonomer, such as described in patent references U.S. Pat. Nos. 6,111,023; 5,677,383; and 6,984,695. EPE resins have a density from 0.905 g/cc, or 0.908 g/cc, or 0.912 g/cc, or 0.920 g/cc to 0.926 g/cc, or 0.929 g/cc, or 0.940 g/cc, or 0.962 g/cc. Nonlimiting examples of EPE resins include ELITE™ enhanced polyethylene (available from The Dow Chemical Company), ELITE AT™ advanced technology resins (available from The Dow Chemical Company), SURPASS™ Polyethylene (PE) Resins (available from Nova Chemicals), and SMART™ (available from SK Chemicals Co.).

“Single-site catalyzed linear low density polyethylenes” (or “m-LLDPE”) are linear ethylene/α-olefin copolymers containing homogeneous short-chain branching distribution comprising units derived from ethylene and units derived from at least one C₃-C₁₀ α-olefin comonomer, or at least one C₄-C₈ α-olefin comonomer, or at least one C₆-C₈ α-olefin comonomer. m-LLDPE has density from 0.913 g/cc, or 0.918 g/cc, or 0.920 g/cc to 0.925 g/cc, or 0.940 g/cc. Nonlimiting examples of m-LLDPE include EXCEED™ metallocene PE (available from ExxonMobil Chemical), LUFLEXEN™ m-LLDPE (available from LyondellBasell), and ELTEX™ PF m-LLDPE (available from Ineos Olefins & Polymers).

“Ethylene plastomers/elastomers” are substantially linear, or linear, ethylene/α-olefin copolymers containing homogeneous short-chain branching distribution comprising units derived from ethylene and units derived from at least one C₃-C₁₀ α-olefin comonomer, or at least one C₄-C₈ α-olefin comonomer, or at least one C₆-C₈ α-olefin comonomer. Ethylene plastomers/elastomers have a density from 0.870 g/cc, or 0.880 g/cc, or 0.890 g/cc to 0.900 g/cc, or 0.902 g/cc, or 0.904 g/cc, or 0.909 g/cc, or 0.910 g/cc, or 0.917 g/cc. Nonlimiting examples of ethylene plastomers/elastomers include AFFINITY™ plastomers and elastomers (available from The Dow Chemical Company), EXACT™ Plastomers (available from ExxonMobil Chemical), Tafmer™ (available from Mitsui), Nexlene™ (available from SK Chemicals Co.), and Lucene™ (available LG Chem Ltd.).

Melt flow rate (MFR) is measured in accordance with ASTM D 1238, Condition 280° C./2.16 kg (g/10 minutes).

Melt index (MI) is measured in accordance with ASTM D 1238, Condition 190° C./2.16 kg (g/10 minutes).

“Melting Point” or “Tm” as used herein (also referred to as a melting peak in reference to the shape of the plotted DSC curve) is typically measured by the DSC (Differential Scanning calorimetry) technique for measuring the melting points or peaks of polyolefins as described in U.S. Pat. No. 5,783,638. It should be noted that many blends comprising two or more polyolefins will have more than one melting point or peak, many individual polyolefins will comprise only one melting point or peak.

Molecular weight distribution (Mw/Mn) is measured using Gel Permeation Chromatography (GPC). In particular, conventional GPC measurements are used to determine the weight-average (Mw) and number-average (Mn) molecular weight of the polymer and to determine the Mw/Mn. The gel permeation chromatographic system consists of either a Polymer Laboratories Model PL-210 or a Polymer Laboratories Model PL-220 instrument. The column and carousel compartments are operated at 140° C. Three Polymer Laboratories 10-micron Mixed-B columns are used. The solvent is 1,2,4 trichlorobenzene. The samples are prepared at a concentration of 0.1 grams of polymer in 50 milliliters of solvent containing 200 ppm of butylated hydroxytoluene (BHT). Samples are prepared by agitating lightly for 2 hours at 160° C. The injection volume used is 100 microliters and the flow rate is 1.0 ml/minute.

Calibration of the GPC column set is performed with 21 narrow molecular weight distribution polystyrene standards with molecular weights ranging from 580 to 8,400,000, arranged in 6 “cocktail” mixtures with at least a decade of separation between individual molecular weights. The standards are purchased from Polymer Laboratories (Shropshire, UK). The polystyrene standards are prepared at 0.025 grams in 50 milliliters of solvent for molecular weights equal to or greater than 1,000,000, and 0.05 grams in 50 milliliters of solvent for molecular weights less than 1,000,000. The polystyrene standards are dissolved at 80° C. with gentle agitation for 30 minutes. The narrow standards mixtures are run first and in order of decreasing highest molecular weight component to minimize degradation. The polystyrene standard peak molecular weights are converted to polyethylene molecular weights using the following equation (as described in Williams and Ward, J. Polym. Sci., Polym. Let., 6, 621 (1968)):

M_{polypropylene}=0.645(M_{polystyrene}).

Polypropylene equivalent molecular weight calculations are performed using Viscotek TriSEC software Version 3.0.

An “olefin-based polymer,” as used herein, is a polymer that contains more than 50 weight percent polymerized olefin monomer (based on total amount of polymerizable monomers), and optionally, may contain at least one comonomer. Nonlimiting examples of olefin-based polymer include ethylene-based polymer and propylene-based polymer.

A “polymer” is a compound prepared by polymerizing monomers, whether of the same or a different type, that in polymerized form provide the multiple and/or repeating “units” or “mer units” that make up a polymer. The generic term polymer thus embraces the term homopolymer, usually employed to refer to polymers prepared from only one type of monomer, and the term copolymer, usually employed to refer to polymers prepared from at least two types of monomers. It also embraces all forms of copolymer, e.g., random, block, etc. The terms “ethylene/α-olefin polymer” and “propylene/α-olefin polymer” are indicative of copolymer as described above prepared from polymerizing ethylene or propylene respectively and one or more additional, polymerizable α-olefin monomer. It is noted that although a polymer is often referred to as being “made of” one or more specified monomers, “based on” a specified monomer or monomer type, “containing” a specified monomer content, or the like, in this context the term “monomer” is understood to be referring to the polymerized remnant of the specified monomer and not to the unpolymerized species. In general, polymers herein are referred to has being based on “units” that are the polymerized form of a corresponding monomer.

A “propylene-based polymer” is a polymer that contains more than 50 weight percent polymerized propylene monomer (based on the total amount of polymerizable monomers) and, optionally, may contain at least one comonomer.

### BRIEF DESCRIPTION OF THE DRAWINGS

FIG. 1 is an exploded perspective view of a packaging article in accordance with an embodiment of the present disclosure.

FIG. 1A is an enlarged perspective view of Area 1A of FIG. 1.

FIG. 2 is a perspective view showing the packaging article of FIG. 1 in a closed configuration.

FIG. 3 is a sectional view taken along line 3-3 of FIG. 2.

FIG. 4 is an exploded perspective view of a packaging article in accordance with an embodiment of the present disclosure.

FIG. 5 is a perspective view showing the packaging article of FIG. 4 in a closed configuration.

FIG. 6 is a sectional view taken along line 6-6 of FIG. 5.

FIG. 7 is an exploded perspective view of a packaging article in accordance with an embodiment of the present disclosure.

FIG. 8 is a perspective view showing the packaging article of FIG. 7 in a closed configuration.

FIG. 9 is a sectional view taken along line 9-9 of FIG. 8.

### DETAILED DESCRIPTION

The present disclosure provides a packaging article. The packaging article includes (A) an insulation container having side walls and a bottom wall. The walls define a compartment. The packaging article includes (B) a cold source in the compartment. The packaging article includes (C) a sheet of 3-dimensional random loop material (3DRLM) in the compartment.

### A. Container

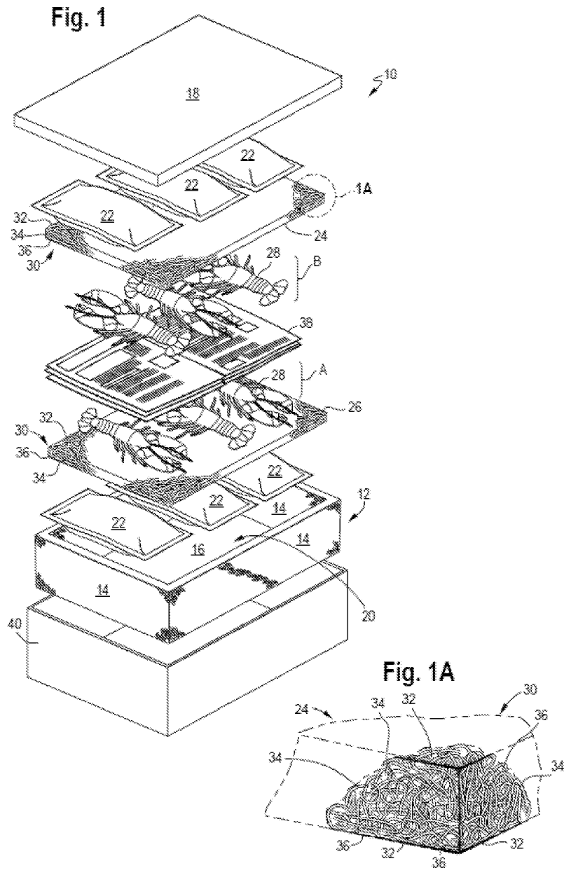

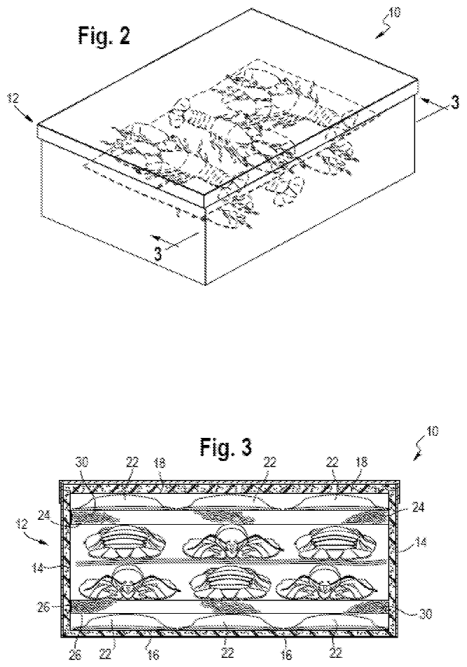

Referring to the drawings and initially to FIGS. 1-3, a packaging article is indicated generally by the reference numeral 10. The packaging article 10 includes a container 12. The container 12 includes sidewalls 14, a bottom wall 16 and a top wall 18. The sidewalls 14 extend between the bottom wall 16 and the top wall 18. Although FIG. 1 shows container 12 with four sidewalls 14, it is understood that the container can have from, three, or four, to five, or six, or seven, or eight, or more sidewalls.

The top wall 18 and/or the bottom wall 16 may or may not be attached to one or more sidewalls. The top wall and/or the bottom wall 18, 16 may comprise one, two, or more flaps attached to respective one, two, or more sidewalls.

In an embodiment, the top wall 18 is a discrete stand-alone component, that is placed on the sidewalls, forming a closed compartment (along with the bottom wall) as shown in FIGS. 1-3.

The walls 14-18 form a compartment 20. The compartment 20 is accessible by removing the top wall 18 from the sidewalls 14.

The walls 14-18 are made of a rigid material. Nonlimiting examples of suitable material for the walls include cardboard, corrugated cardboard, polymeric material, metal, wood, fiberglass, insulative material and any combination thereof.

In an embodiment, the container 12 is an insulated container. An “insulated container,” as used herein is a container that that prevents, or reduces, the passage of heat. Nonlimiting examples of an insulated container include a vacuum flask (Thermos™ bottle), a container with a thermal blanket or a thermal liner, a molded expanded polystyrene (EPS) container, a molded polyurethane foam container, a molded polyethylene foam container, a container with a liner of reflective material (metallized film), a container with a liner of bubble wrap, and any combination thereof.

In an embodiment, the insulated container is a molded EPS container as shown in FIGS. 1-3.

The container may comprise two or more embodiments disclosed herein.

### B. Cold Source

The present packaging article includes a cold source. A “cold source,” as used herein, is an object that produces, or radiates, cold. Nonlimiting examples of a cold source include a wet ice pack, a bottle of ice, a dry ice (frozen CO₂) pack, a refrigerant pack (typically water and ammonium nitrate, and including a frozen gel pack), and any combination thereof.

In an embodiment, cold source is an ice pack, or a bottle of ice.

In an embodiment, the cold source is one or more refrigerant packs 22. FIGS. 1 and 3 show refrigerant packs 22 located in the compartment 20. Although FIGS. 1 and 3 show six refrigerant packs 22, it is understood that from 1, or 2, or 3, or 4, or 5, or 6 to 7, or 8, or 9, or 10, or 11, or 12, or more refrigerant packs may be present in the compartment 20.

The cold source may comprise two or more embodiments disclosed herein.

### C. 3-Dimensional Random Loop Material

The packaging article 10 includes at least one sheet of a 3-dimensional random loop material 30. As best seen in FIGS. 1, 1A, a “3-dimensional random loop material” (or “3DRLM”) is a mass or a structure of a multitude of loops 32 formed by allowing continuous fibers 34, to wind, permitting respective loops to come in contact with one another in a molten state and to be heat-bonded, or otherwise melt-bonded, at most of the contact points 36. Even when a great stress to cause significant deformation is given, the 3DRLM 30 absorbs the stress with the entire net structure composed of three-dimensional random loops melt-integrated, by deforming itself; and once the stress is lifted, elastic resilience of the polymer manifests itself to allow recovery to the original shape of the structure. When a net structure composed of continuous fibers made from a known non-elastic polymer is used as a cushioning material, plastic deformation is developed and the recovery cannot be achieved, thus resulting in poor heat-resisting durability. When the fibers are not melt-bonded at contact points, the shape cannot be retained and the structure does not integrally change its shape, with the result that a fatigue phenomenon occurs due to the concentration of stress, thus unbeneficially degrading durability and deformation resistance. In certain embodiments, melt-bonding is the state where all contact points are melt-bonded.

A nonlimiting method for producing 3DRLM 30 includes the steps of (a) heating a molten olefin-based polymer, at a temperature 10° C.-140° C. higher than the melting point of the polymer in a typical melt-extruder; (b) discharging the molten interpolymer to the downward direction from a nozzle with plural orifices to form loops by allowing the fibers to fall naturally (due to gravity). The polymer may be used in combination with a thermoplastic elastomer, thermoplastic non-elastic polymer or a combination thereof. The distance between the nozzle surface and take-off conveyors installed on a cooling unit for solidifying the fibers, melt viscosity of the polymer, diameter of orifice and the amount to be discharged are the elements which decide loop diameter and fineness of the fibers. Loops are formed by holding and allowing the delivered molten fibers to reside between a pair of take-off conveyors (belts, or rollers) set on a cooling unit (the distance therebetween being adjustable), bringing the loops thus formed into contact with one another by adjusting the distance between the orifices to this end such that the loops in contact are heat-bonded, or otherwise melt-bonded, as they form a three-dimensional random loop structure. Then, the continuous fibers, wherein contact points have been heat-bonded, or otherwise melt bonded, as the loops form a three-dimensional random loop structure, are continuously taken into a cooling unit for solidification to give a net structure. Thereafter, the structure is cut into a desired length and shape. The method is characterized in that the olefin-based polymer is melted and heated at a temperature 10° C.-140° C. higher than the melting point of the interpolymer and delivered to the downward direction in a molten state from a nozzle having plural orifices. When the polymer is discharged at a temperature less than 10° C. higher than the melting point, the fiber delivered becomes cool and less fluidic to result in insufficient heat-bonding of the contact points of fibers.

Properties, such as, the loop diameter and fineness of the fibers constituting the cushioning net structure provided herein depend on the distance between the nozzle surface and the take-off conveyor installed on a cooling unit for solidifying the interpolymer, melt viscosity of the interpolymer, diameter of orifice and the amount of the interpolymer to be delivered therefrom. For example, a decreased amount of the interpolymer to be delivered and a lower melt viscosity upon delivery result in smaller fineness of the fibers and smaller average loop diameter of the random loop. On the contrary, a shortened distance between the nozzle surface and the take-off conveyor installed on the cooling unit for solidifying the interpolymer results in a slightly greater fineness of the fiber and a greater average loop diameter of the random loop. These conditions in combination afford the desirable fineness of the continuous fibers of from 100 denier to 100000 denier and an average diameter of the random loop of not more than 100 mm, or from 1 millimeter (mm), or 2 mm, or 10 mm to 25 mm, or 50 mm. By adjusting the distance to the aforementioned conveyor, the thickness of the structure can be controlled while the heat-bonded net structure is in a molten state and a structure having a desirable thickness and flat surface formed by the conveyors can be obtained. Too great a conveyor speed results in failure to heat-bond the contact points, since cooling proceeds before the heat-bonding. On the other hand, too slow a speed can cause higher density resulting from excessively long dwelling of the molten material. In some embodiments the distance to the conveyor and the conveyor speed should be selected such that the desired apparent density of 0.005-0.1 g/cc or 0.01-0.05 g/cc can be achieved.

In an embodiment, the 3DRLM 30 has, one, some, or all of the properties (i)-(iii) below:

(i) an apparent density from 0.016 g/cc, or 0.024 g/cc, or 0.032 g/cc, or 0.040 g/cc, or 0.050 g/cc, or 0.060 to 0.070, or 0.080, or 0.090, or 0.100, or 0.150 and/or

(ii) a fiber diameter from 0.1 mm, or 0.5 mm, or 0.7 mm, or 1.0 mm or 1.5 mm to 2.0 mm to 2.5 mm, or 3.0 mm; and/or

(iii) a thickness (machine direction) from 1.0 cm, 2.0 cm, or 3.0, cm, or 4.0 cm, or 5.0 cm, or 10 cm, or 20 cm, to 50 cm, or 75 cm, or 100 cm, or more. It is understood that the thickness of the 3DRLM 30 will vary based on the type of product to be packaged.

The 3DRLM 30 is formed into a three dimensional geometric shape to form a sheet (i.e., a prism). The 3DRLM 30 is an elastic material which can be compressed and stretched and return to its original geometric shape. An “elastic material,” as used herein, is a rubber-like material that can be compressed and/or stretched and which expands/retracts very rapidly to approximately its original shape/length when the force exerting the compression and/or the stretching is released. The three dimensional random loop material 30 has a “neutral state” when no compressive force and no stretch force is imparted upon the 3DRLM 30. The three dimensional random loop material 30 has “a compressed state” when a compressive force is imparted upon the 3DRLM 30. The three dimensional random loop material 30 has “a stretched state” when a stretching force is imparted upon the 3DRLM 30.

The three dimensional random loop material 30 is composed of one or more olefin-based polymers. The olefin-based polymer can be one or more ethylene-based polymers, one or more propylene-based polymers, and blends thereof.

In an embodiment, the ethylene-based polymer is an ethylene/α-olefin polymer. Ethylene/α-olefin polymer may be a random ethylene/α-olefin polymer or an ethylene/α-olefin multi-block polymer. The α-olefin is a C₃-C₂₀ α-olefin , or a C₄-C₁₂ α-olefin , or a C₄-C₈ α-olefin. Nonlimiting examples of suitable α-olefin comonomer include propylene, butene, methyl-1-pentene, hexene, octene, decene, dodecene, tetradecene, hexadecene, octadecene, cyclohexyl-1-propene (allyl cyclohexane), vinyl cyclohexane, and combinations thereof.

In an embodiment, the ethylene-based polymer is a homogeneously branched random ethylene/α-olefin copolymer.

“Random copolymer” is a copolymer wherein the at least two different monomers are arranged in a non-uniform order. The term “random copolymer” specifically excludes block copolymers. The term “homogeneous ethylene polymer” as used to describe ethylene polymers is used in the conventional sense in accordance with the original disclosure by Elston in U.S. Pat. No. 3,645,992, the disclosure of which is incorporated herein by reference, to refer to an ethylene polymer in which the comonomer is randomly distributed within a given polymer molecule and wherein substantially all of the polymer molecules have substantially the same ethylene to comonomer molar ratio. As defined herein, both substantially linear ethylene polymers and homogeneously branched linear ethylene are homogeneous ethylene polymers.

The homogeneously branched random ethylene/α-olefin copolymer may be a random homogeneously branched linear ethylene/α-olefin copolymer or a random homogeneously branched substantially linear ethylene/α-olefin copolymer. The term “substantially linear ethylene/α-olefin copolymer” means that the polymer backbone is substituted with from 0.01 long chain branches/1000 carbons to 3 long chain branches/1000 carbons, or from 0.01 long chain branches/1000 carbons to 1 long chain branches/1000 carbons, or from 0.05 long chain branches/1000 carbons to 1 long chain branches/1000 carbons. In contrast, the term “linear ethylene/α-olefin copolymer” means that the polymer backbone has no long chain branching.

The homogeneously branched random ethylene/α-olefin copolymers may have the same ethylene/α-olefin comonomer ratio within all copolymer molecules. The homogeneity of the copolymers may be described by the SCBDI (Short Chain Branch Distribution Index) or CDBI (Composition Distribution Branch Index) and is defined as the weight percent of the polymer molecules having a comonomer content within 50 percent of the median total molar comonomer content. The CDBI of a polymer is readily calculated from data obtained from techniques known in the art, such as, for example, temperature rising elution fractionation (abbreviated herein as “TREF”) as described in U.S. Pat. No. 4,798,081 (Hazlitt et al.), or in U.S. Pat. No. 5,089,321 (Chum et al.) the disclosures of all of which are incorporated herein by reference. The SCBDI or CDBI for the homogeneously branched random ethylene/α-olefin copolymers is preferably greater than about 30 percent, or greater than about 50 percent.

The homogeneously branched random ethylene/α-olefin copolymer may include at least one ethylene comonomer and at least one C₃-C₂₀ α-olefin, or at least one C₄-C₁₂ α-olefin comonomer. For example and not by way of limitation, the C₃-C₂₀ α-olefins may include but are not limited to propylene, isobutylene, 1-butene, 1-hexene, 4-methyl-1-pentene, 1-heptene, 1-octene, 1-nonene, and 1-decene, or, in some embodiments, 1-butene, 1-hexene, 4-methyl-1-pentene and 1-octene.

The homogeneously branched random ethylene/α-olefin copolymer may have one, some, or all of the following properties (i)-(iii) below:

(i) a melt index (I₂) from 1 g/10 min, or 5 g/10 min, or 10 g/10 min, or 20 g/10 min to 30 g/10 min, or 40 g/10 min, or 50 g/10 min, and/or

(ii) a density from 0.075 g/cc, or 0.880 g/cc, or 0.890 g/cc to 0.90 g/cc, or 0.91 g/cc, or 0.920 g/cc, or 0.925 g/cc; and/or

(iii) a molecular weight distribution (Mw/Mn) from 2.0, or 2.5, or 3.0 to 3.5, or 4.0.

In an embodiment, the ethylene-based polymer is a heterogeneously branched random ethylene/α-olefin copolymer.

The heterogeneously branched random ethylene/α-olefin copolymers differ from the homogeneously branched random ethylene/α-olefin copolymers primarily in their branching distribution. For example, heterogeneously branched random ethylene/α-olefin copolymers have a distribution of branching, including a highly branched portion (similar to a very low density polyethylene), a medium branched portion (similar to a medium branched polyethylene) and an essentially linear portion (similar to linear homopolymer polyethylene).

Like the homogeneously branched random ethylene/α-olefin copolymer, the heterogeneously branched random ethylene/α-olefin copolymer may include at least one ethylene comonomer and at least one C₃-C₂₀ α-olefin comonomer, or at least one C₄-C₁₂ α-olefin comonomer. For example and not by way of limitation, the C₃-C₂₀ α-olefins may include but are not limited to, propylene, isobutylene, 1-butene, 1-hexene, 4-methyl-1-pentene, 1-heptene, 1-octene, 1-nonene, and 1-decene, or, in some embodiments, 1-butene, 1-hexene, 4-methyl-1-pentene and 1-octene. In one embodiment, the heterogeneously branched ethylene/α-olefin copolymer may comprise greater than about 50% by wt ethylene comonomer, or greater than about 60% by wt., or greater than about 70% by wt. Similarly, the heterogeneously branched ethylene/α-olefin copolymer may comprise less than about 50% by wt α-olefin monomer, or less than about 40% by wt., or less than about 30% by wt.

The heterogeneously branched random ethylene/α-olefin copolymer may have one, some, or all of the following properties (i)-(iii) below:

(i) a density from 0.900 g/cc, or 0.0910 g/cc, or 0.920 g/cc to 0.930 g/cc, or 0.094 g/cc;

(ii) a melt index (I₂) from 1 g/10 min, or 5 g/10 min, or 10 g/10 min, or 20 g/10 min to 30 g/10 min, or 40 g/10 min, or 50 g/10 min; and/or

(iii) an Mw/Mn from 3.0, or 3.5 to 4.0, or 4.5.

In an embodiment, the 3DRLM 30 is composed of a blend of a homogeneously branched random ethylene/α-olefin copolymer and a heterogeneously branched ethylene/α-olefin copolymer, the blend having one, some, or all of the properties (i)-(v) below:

(i) a Mw/Mn from 2.5, or 3.0 to 3.5, or 4.0, or 4.5;

(ii) a melt index (I₂) from 3.0 g/10 min, or 4.0 g/10 min, or 5.0 g/10 min, or 10 g/10 min to 15 g/10 min, or 20 g/10 min, or 25 g/10 min;

(iii) a density from 0.895 g/cc, or 0.900 g/cc, or 0.910 g/cc, or 0.915 g/cc to 0.920 g/cc, or 0.925 g/cc; and or

(iv) an I₁₀/I₂ ratio from 5 g/10 min, or 7 g/10 min to 10 g/10 min, or 15 g/10 min; and/or

(v) a percent crystallinity from 25%, or 30%, or 35%, or 40% to 45%, or 50%, or 55%.

According to Crystallization Elution Fractionation (CEF), the ethylene/α-olefin copolymer blend may have a weight fraction in a temperature zone from 90° C. to 115° C. or about 5% to about 15% by wt., or about 6% to about 12%, or about 8% to about 12%, or greater than about 8%, or greater than about 9%. Additionally, as detailed below, the copolymer blend may have a Comonomer Distribution Constant (CDC) of at least about 100, or at least about 110.

The present ethylene/α-olefin copolymer blend may have at least two, or three melting peaks when measured using Differential Scanning calorimetry (DSC) below a temperature of 130° C. In one or more embodiments, the ethylene/α-olefin copolymer blend may include a highest temperature melting peak of at least 115° C., or at least 120° C., or from about 120° C. to about 125° C., or from about from 122 to about 124° C. Without being bound by theory, the heterogeneously branched ethylene/α-olefin copolymer is characterized by two melting peaks, and the homogeneously branched ethylene/α-olefin copolymer is characterized by one melting peak, thus making up the three melting peaks.

Additionally, the ethylene/α-olefin copolymer blend may comprise from about 10 to about 90% by weight, or about 30 to about 70% by weight, or about 40 to about 60% by weight of the homogeneously branched ethylene/α-olefin copolymer. Similarly, the ethylene/α-olefin copolymer blend may comprise from about 10 to about 90% by weight, about 30 to about 70% by weight, or about 40 to about 60% by weight of the heterogeneously branched ethylene/α-olefin copolymer. In a specific embodiment, the ethylene/α-olefin copolymer blend may comprise from about 50% to about 60% by weight of the homogeneously branched ethylene/α-olefin copolymer, and 40% to about 50% of the heterogeneously branched ethylene/α-olefin copolymer.

Moreover, the strength of the ethylene/α-olefin copolymer blend may be characterized by one or more of the following metrics. One such metric is elastic recovery. Here, the ethylene/α-olefin copolymer blend has an elastic recovery, Re, in percent at 100 percent strain at 1 cycle of between 50-80%. Additional details regarding elastic recovery are provided in U.S. Pat. No. 7,803,728, which is incorporated by reference herein in its entirety.

The ethylene/α-olefin copolymer blend may also be characterized by its storage modulus. In some embodiments, the ethylene/α-olefin copolymer blend may have a ratio of storage modulus at 25° C., G′ (25° C.) to storage modulus at 100° C., G′ (100° C.) of about 20 to about 60, or from about 20 to about 50, or about 30 to about 50, or about 30 to about 40.

Moreover, the ethylene/α-olefin copolymer blend may also be characterized by a bending stiffness of at least about 1.15 Nmm at 6 s, or at least about 1.20 Nmm at 6 s, or at least about 1.25 Nmm at 6 s, or at least about 1.35 Nmm at 6 s. Without being bound by theory, it is believed that these stiffness values demonstrate how the ethylene/α-olefin copolymer blend will provide cushioning support when incorporated into 3DRLM fibers bonded to form a cushioning net structure.

In an embodiment, the ethylene-based polymer is an ethylene/α-olefin interpolymer composition having one, some, or all of the following properties (i)-(v) below:

(i) a highest DSC temperature melting peak from 90.0° C. to 115.0° C.; and/or

(ii) a zero shear viscosity ratio (ZSVR) from 1.40 to 2.10; and/or

(iii) a density in the range of from 0.860 to 0.925 g/cc; and/or

(iv) a melt index (I₂) from 1 g/10 min to 25 g/10 min; and/or

(v) a molecular weight distribution (Mw/Mn) in the range of from 2.0 to 4.5.

In an embodiment, the ethylene-based polymer contains a functionalized commoner such as an ester. The functionalized comonomer can be an acetate commoner oran acrylate comonomer. Nonlimiting examples of suitable ethylene-based polymer with functionalized comonomer include ethylene vinyl acetate (EVA), ethylene methyl acrylate EMA, ethylene ethyl acrylate (EEA), and any combination thereof.

In an embodiment, the olefin-based polymer is a propylene-based polymer. The propylene-based polymer can be a propylene homopolymer or a propylene/α-olefin polymer. The α-olefin is a C₂ α-olefin (ethylene) or a C₄-C₁₂ α-olefin , or a C₄-C₈ α-olefin. Nonlimiting examples of suitable α-olefin comonomer include ethylene, butene, methyl-1-pentene, hexene, octene, decene, dodecene, tetradecene, hexadecene, octadecene, cyclohexyl-1-propene (allyl cyclohexane), vinyl cyclohexane, and combinations thereof.

In an embodiment, the propylene interpolymer includes from 82 wt % to 99 wt % units derived from propylene and from 18 wt % to 1 wt % units derived from ethylene, having one, some, or all of the properties (i)-(vi) below:

(i) a density of from 0.840 g/cc, or 0.850 g/cc to 0.900 g/cc; and/or

(ii) a highest DSC melting peak temperature from 50.0° C. to 120.0° C.; and/or

(iii) a melt flow rate (MFR) from 1 g/10 min, or 2 g/10 min to 50 g/10 min, or 100 g/10 min; and/or

(iv) a Mw/Mn of less than 4; and/or

(v) a percent crystallinity in the range of from 0.5% to 45%; and/or

(vi) a DSC crystallization onset temperature, Tc-Onset, of less than 85° C.

In an embodiment, the olefin-based polymer used in the manufacture of the 3DRLM 30 contains one or more optional additives. Nonlimiting examples of suitable additives include stabilizer, antimicrobial agent, antifungal agent, antioxidant, processing aid, ultraviolet (UV) stabilizer, slip additive, antiblocking agent, color pigment or dyes, antistatic agent, filler, flame retardant, and any combination thereof.

### D. Sheets

Returning to FIGS. 1-3, the packaging article 10 includes an upper sheet 24 and a lower sheet 26. Each sheet 24, 26, is made of 3DRLM 30. Consequently, each sheet 24, 26 can move to/from a compressed state, to/from a neutral state, and to/from a stretched state. The composition, and/or the size, and/or the shape of each sheet 24, 26 may be the same or different. In an embodiment, the composition, the size, and the shape of upper sheet 24 is the same as, or substantially the same as, the composition, size, and shape of the lower sheet 26.

In an embodiment, the upper sheet 24 extends between and contacts at least two opposing sidewalls of the container 12.l The lower sheet 26 extends between and contacts at least two opposing sidewalls of the container 12. Upper sheet 24 is in opposing relation to lower sheet 26.

In an embodiment, each sheet 24, 26 is sized and shaped to friction fit against opposing sidewalls when placed in the compartment 20. In a further embodiment, each sheet 24,26 is removable from the container. Each sheet 24,26 is thereby reusable and/or recyclable.

E. Temperature Sensitive Product

The packaging article 10 includes a temperature sensitive product. A “temperature sensitive product,” (or “TSP”) as used herein, is a product that has a storage temperature cooler than controlled room temperature (68° F.-74° F., or 20° C.-24° C.), and/or a product that is sensitive to temperature variation. Nonlimiting examples of temperature sensitive products include seafood, live seafood, frozen food, medicines, biopharmaceuticals, biogenetic material, vaccines, blood, biologic materials, chemicals, confections, cryogenic materials, temperature sensitive gifts, plants, flowers or floral arrangements, human genetic material, human organs/body parts, animal genetic material, animal organs/body parts, biomass and any combination thereof.

In an embodiment, the TSP is live seafood that is one or more live lobsters 28 as shown in FIGS. 1-3. The plurality of live lobsters can be arranged in a horizontal manner or in a vertical manner in the compartment 20.

In an embodiment, the live lobsters 28 are stacked in a horizontal manner in the compartment 20 as shown in FIGS. 1-3. One or more cold sources (such as refrigerant packs 22) are placed in the compartment 20 on the bottom wall 16. Lower sheet 24 of 3DRLM 30 is placed over, or otherwise is placed on top of, the refrigerant packs 22.l A first layer, layer A, of live lobsters 28 is placed on the lower sheet 26. A second layer, layer B, of live lobsters 28 is placed on top of the layer A.

Upper sheet 26 is placed on top of layer B, the second layer of live lobsters 28. Optionally, one or more cold sources (refrigerant pack 22) is/are placed on top of the upper sheet 24. Another sheet of 3DRLM 30 may be placed between layer A and layer B. The top wall 18 is placed on top of the sidewalls 14 to enclose, or completely enclose, the compartment 20.

Each sheet (upper/lower sheets 24, 26l of the 3DRLM 30 is located between the TSP and the cold sources. In this way, the 3DRLM 30 material prevents contact between the cold source(s) and the TSP, the live lobsters 28. Upper/lower sheets 24/26 of 3DRLM 30 advantageously provide uniform, reliable radiant flow of cool air from the cold sources to the live lobsters 28. The open loop structure of the 3DRLM 30 promotes unobstructed cool air flow from the refrigerant packs 22 to the live lobsters 28. Simultaneously, the resilience and strength of the 3DRLM 30 of each sheet 24, 26 supports the live lobsters 28 and is a physical barrier between the TSP of live lobster and the cold sources. This “open-cold-flow and barrier” feature of the sheets 24, 26 of 3DRLM 30 prevents undesired spikes in cold air, enabling control of temperature during transport. The sheets 24, 26 and conjunction with the cold sources 22 promote uniform cooling of the TSP in the compartment 20.

The resiliency and elasticity of the 3DRLM 30 advantageously absorbs vibrational forces to reduce the vibrational stress on the TSP during shipping.

The packaging article 10 may optionally include a moisture source. In an embodiment, the moisture source is one or more wet papers 38 (such as wet newspaper, for example). An optional layer of wet paper 38 can be placed between layer A and layer B. One or more additional wet paper layers may also be placed between layer lower sheet 26 and layer A, and/or between layer B and upper sheet 24.

The open loop structure of the 3DRLM 30 enables breathability and moisture transfer through the open loop structure of the 3DRLM 30.

In an embodiment, moisture condensation from refrigerant packs 22 passes through the open loops of the 3DRLM 30 to contribute to the moisture/humidity control for the live lobsters 28. In this way, the cold source can function as both a cold source and a moisture source.

In an embodiment, the container 12 may be placed in an outer container 40, such as a shipping container, for example.

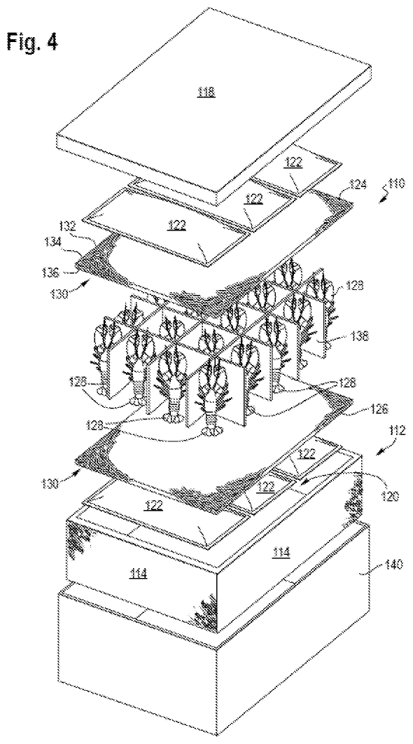

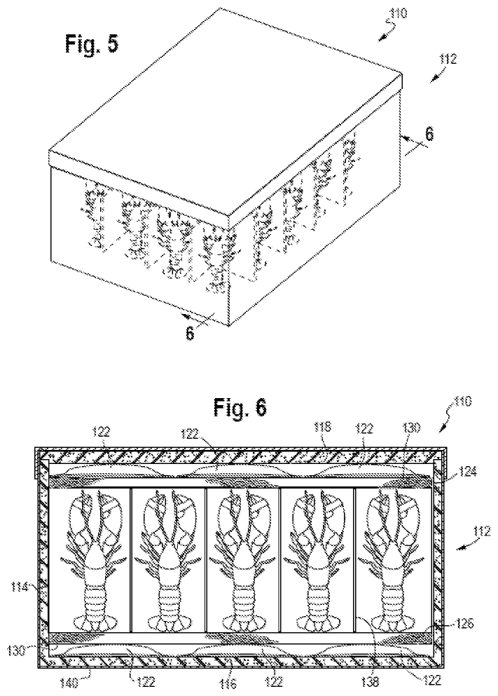

FIGS. 4-6 show a packaging article 110 having an insulation container 112. The insulation container 112 has sidewalls 114, a bottom wall 116 and a top wall 118 to form a compartment 120 as previously disclosed. The insulation container 112 may be any insulation container as previously disclosed herein. Upper sheet 124 and lower sheet 126 of 3DRLM 130 separate live lobsters 28 from cold sources, ice packs 122. The 3DRLM 130 can be any 3DRLM (with loops 132, fibers 134, and contact points 136) as disclosed above.

FIGS. 4-6 show the live lobsters 128 are stacked in a vertical arrangement in the compartment 120. A partition unit 138 provides individual compartments for each lobster. The partition unit 138 separates the individual live lobsters from each other. The partition unit 138 also supports the live lobsterb 128 in a vertical position. In an embodiment, the partition unit 138 supports each live lobster 128 in a vertical position that is a tail down-head up position.

Upper sheetb 124 and lower sheet 126 (each sheet made of 3DRLM 130) prevent contact between the one or more cold sources 222 and the live lobsters 128. The cold sources 222 may be any cold source as previously disclosed above.

The packaging article may optionally include a moisture source as previously disclosed above.

In an embodiment, the insulation container 112 is placed in an outer container 140.

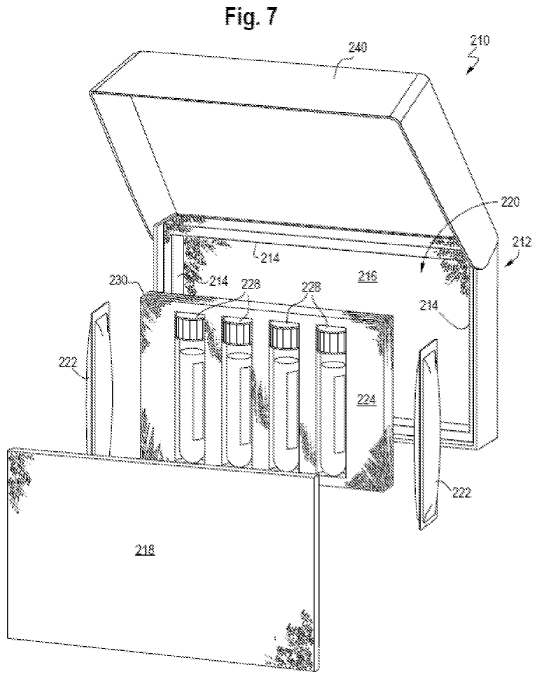

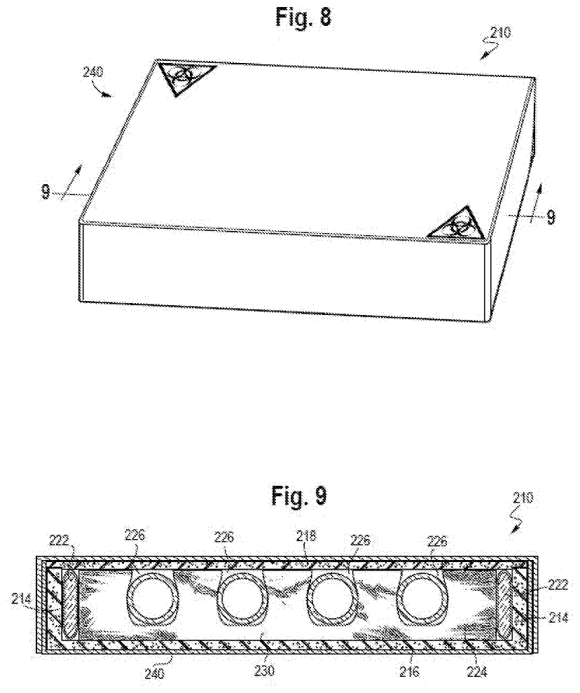

FIGS. 7-9 show a packing article 210 having an insulation container 212. The insulation containerb 212 has sidewalls 214, a bottom wall 216, and a top wall 218l to form a compartment 220 as previously disclosed. The insulation containerb 212 may be any insulation container as previously disclosed herein. The packaging article 210 includes a sheet 224 of 3DRLM 230. The 3DRLM 230 can be any 3DRLM as disclosed above. The sheet 224 includes one or more cut-outs 226, each adapted to receive a respective bottle 228. A “cut-out” is a shape formed into the 3DRLM of the sheet 224, the shape creating a void in the 3DRLM, the shaped-void pre-determined and adapted to receive at least a portion of, or all of, the bottle 228. The size and shape of the shaped-void is adapted to the size and shape of the bottle to be packaged. The cut-out may be formed in a molding process, a cutting procedure, and combinations thereof. The cut-out is present when the 3DRLM is in the neutral state, the cut-out portion being distinct from the compressed state and/or the stretched state of the 3DRLM 30. In this sense, the cut-out is a void shape that is reciprocal in shape to the positive space and shape (or a portion of the positive space and shape) occupied by the bottle 228.

The bottle 228 can be a vial, an ampule, a test tube, and any combination thereof. Each bottle holds, or otherwise contains, a TSP that is flowable. Non limiting examples of flowable TSP for bottle 228 include medicines, biopharmaceuticals, vaccines, blood, biologic materials, chemicals, and any combination thereof.

In an embodiment, a portion of the 3DRLM 230 moves from a neutral state to a stretched state when one or more of the bottles 228 is/are inserted into respective cut-outs 226. As the bottle 228 is inserted into the cut-out 226, the bottle 228 stretches the 3DRLM 230. The 3DRLM 230 in contact with the bottle 228 stretches around the inserted bottle, such that the 3DRLM 230 imparts an elastic and compressive contact on and around the bottle 228. In this way, the 3DRLM 230 intimately contacts, or otherwise imparts a squeezing force, around opposing sides, or around two sides, or around three sides of the bottle 228. The squeezing force of the stretched state 3DRLM 230 around the bottle 228 in the cut-out 226 enables the sheet 224 to apply a restraining force, or a holding force, upon the bottle(s) 228 in the sheet 224.

The packaging article 230 includes one or more cold sources 222.l In an embodiment, the cold source(s) may be any cold source as previously disclosed herein. The open loop structure of the 3DRLM 230 enables cool air from each cold source 222 to flow through the sheet 224 and cool the bottles 228. In this way, the packaging articleb 230 advantageously provides a side-by-side arrangement of cold sources-to-bottles whereby the opposing cold sources 222 sandwich the sheet 224 (and thereby the cold sources 222 sandwich the bottles 228). In other words, the cold sources 222 are at essentially the same level (or at the same layer) as the TSP. Although a side-by-side arrangement of cold sources 222 and sheet 224 is shown in FIGS. 7 and 9, it is understood that cold sources 222 can be arranged in an upper and a lower arrangement with respect to the sheet 224 alone, or in addition to, the side-by-side arrangement shown in FIGS. 7 and 9. In addition to serving as a conduit for the cool flow of air, the 3DRLM 230 of sheet 224 simultaneously holds the bottles 228 firmly in place within the compartment 220. The sheeb 224 provides a protective cushion around the bottles 228 providing cushioning and protection from vertical shock of the bottles 228 in the container 212.

The packaging article 210 may optionally include an outer containerb 240 in which container 212 is placed. In an embodiment, the outer container 240 is a roll end lock front container or a “RELF” container. The RELF container may or may not include dust flaps.

In an embodiment, the packaging article 10, 110, and/or 210 maintains TSP at a temperature from 0° C., or 2° C., or 5° C. to 8° C., or 10° C., or 12° C., or 15° C. for a duration from 6 hours, or 8 hours or 10 hours, or 12 hours, or 14 hours, or 16 hours or 18 hours, or 20 hours to 24 hours, or 36 hours, or 48 hours, or 60 hours, upon fully enclosing respective insulated container 12, 112, and/or 212.

Applicant discovered that packaging container 10, 110, 210 advantageously:

(i) protect the temperature sensitive product from direct contact with the cold source while simultaneously enhancing breathability and cooling effect to the container compartment compared to containers with conventional packing peanuts, bubble-out bags, air pillow, bubble wrap, and foam sheets; and/or

(ii) provide cushioning and protection from falls, drops, tips, puncture, vibration and environmental stresses to the temperature sensitive product during shipping and handling; and/or

(iii) provide one or more sheets of 3DRLM which can be readily removed from the packaging container and easily washed; and/or

(iv) provide one or more sheets of 3DRLM which can be readily removed from the packaging container and be recycled or re-used.

It is specifically intended that the present disclosure not be limited to the embodiments and illustrations contained herein, but include modified forms of those embodiments including portions of the embodiments and combinations of elements of different embodiments as come with the scope of the following claims.

1. A packaging article comprising:
A. an insulation container having side walls and a bottom wall, the walls defining a compartment;
B. a cold source in the compartment; and
C. a sheet of 3-dimensional random loop material (3DRLM) in the compartment.

2. The packaging article of claim 1 wherein the container comprises a top wall.

3. The packaging article of claim 1 comprising a temperature sensitive product in the compartment; and
the sheet of 3DRLM is located between the temperature sensitive product and the cold source.

4. The packaging article of claim 3 wherein the sheet of 3DRLM prevents contact between the cold source and the temperature sensitive product.

5. The packaging article of claim 3 wherein the one or more cold sources are at a location selected from the group consisting of above the temperature sensitive product, below temperature sensitive product, to the side of the temperature sensitive product, and combinations thereof

6. The packaging article of claim 3 wherein the temperature sensitive product is one or more live lobsters.

7. The packaging article of claim 6 wherein at least one cold source is below the live lobsters.

8. The packaging article of claim 6 comprising a moisture source.

9. The packaging article of claim 1 wherein the sheet of 3DRLM extends across two opposing walls.

10. The packaging article of claim 1 comprising two or more layers of the temperature sensitive product in the compartment.

11. The packaging article of claim 1 wherein the insulation container is located in an outer container.

12. The packaging article of claim 3 wherein the temperature sensitive product is bottle containing a material selected from the group consisting of medicine, biopharmaceutical, vaccine, blood, biologic material, chemical, and any combination thereof.

13. The packaging article of claim 12 wherein the sheet of 3DRLM comprises a cut-out adapted to receive at least a portion of the bottle.

14. The packaging article of claim 13 wherein a portion of the 3DRLM moves from a neutral state to a stretched state when the bottle is inserted into the cut-out.

15. The packaging article of claim 14 wherein the 3DRLM in the stretched state imparts a restraining force upon the bottle and holds the bottle in the sheet.
